(19) United States
(12) Patent Application Publication
(10) Pub. No.: US 2025/0114946 A1
(43) Pub. Date: Apr. 10, 2025

(54) METHOD FOR ADJUSTING ROBOT PATH, COMPUTING DEVICE, AND COMPUTER READABLE STORAGE MEDIUM

(71) Applicant: ABB SCHWEIZ AG, Baden (CH)

(72) Inventors: Kun CHANG, Shanghai (CN); Lei MAO, Shanghai (CN); Yin TIAN, Shanghai (CN); Meng XU, Shanghai (CN)

(21) Appl. No.: 18/988,031

(22) Filed: Dec. 19, 2024

Related U.S. Application Data
(63) Continuation of application No. PCT/CN2022/107505, filed on Jul. 22, 2022.

(51) Int. Cl. B25J 13/00; B25J 13/08; G10L 15/22

(52) U.S. Cl. CPC B25J 13/003; B25J 13/089; G10L 15/22; G10L 2015/223

(57) ABSTRACT

Embodiments of present disclosure relate to a method of adjusting robot path, a computing device, and a computer readable storage medium. The method comprises: obtaining a plurality of scanned contours of a tool held by a robot by scanning the tool at a plurality of positions using a laser sensor; determining, based on the plurality of scanned contours, the plurality of positions in an actual trajectory of the tool; determining the actual trajectory based on the plurality of positions; and adjusting the robot path based on a deviation between the actual trajectory and a theoretical trajectory of the tool. In this way, contour sampling data of the tool with high precision can be analyzed to correct the actual path data to fit the desired one, so as to improve the path accuracy.

### FIELD

Embodiments of the present disclosure generally relate to the field of robotics, and more particularly, to a method for adjusting robot path with line laser, a computing device, and a computer readable storage medium.

### BACKGROUND

Industrial robots are widely used in production. With the rapid development of robot technology and the increasing expansion of application fields, the production environment and process requirements become more and more complex, and the requirements for robot positioning accuracy in industrial production become higher and higher. Accuracy is a very important index to measure the quality of a six-axis robot. The accuracy of a six-axis robot mainly involves “absolute positioning accuracy”, “repeated positioning accuracy”, “absolute path accuracy”, “repeated path accuracy”, etc. Among them, “repeated positioning accuracy” is an important one.

However, in practical production and application, due to some problems, for example manufacturing or assembly errors of internal parts of robot body, it is almost impossible for industrial robots to traverse a perfect circular, linear or rectangular paths, which will affect the operation effect of high-precision applications. Therefore, there is still room for continuous improvement in work efficiency and operation accuracy.

### SUMMARY

In view of the foregoing problems, example embodiments of the present disclosure propose solutions for robot path correction to improve the positioning accuracy.

In a first aspect of the present disclosure, example embodiments of the present disclosure provide a method of adjusting a robot path. The method comprises: obtaining a plurality of scanned contours of a tool held by a robot travelling along the robot path by scanning the tool using a laser sensor; determining, based on the plurality of scanned contours, a plurality of positions in an actual trajectory of the tool; determining the actual trajectory based on the plurality of positions; and adjusting the robot path based on a deviation of the actual trajectory from a theoretical trajectory of the tool. With these embodiments, when the robot travels along a path, a laser sensor, e.g., line laser equipment is used to scan the movement of the tool held by the robot to obtain a set of scanned contours of the tool at different positions with very high precision. By processing and analyzing the scanned contour, a deviation of the actual trajectory and the theoretical trajectory can be determined. The deviation thus can be used to adjust the robot path to achieve robot path correction and therefore improve the position accuracy of the robot. It should be appreciated that one or more laser sensor can be used to detect the contour of the tool. For example, a plurality of laser sensors can be distributed around the robot to detect different parts of the contour at the same time. The present disclosure is not intended to limit the number of the laser sensor.

In some embodiments, obtaining the plurality of scanned contours comprises: obtaining a plurality of sets of contour points, each set of contour points corresponding to one of the plurality of scanned contours and being detected by the laser sensor at one of the plurality of positions in the actual trajectory. With these embodiments, when the laser sensor scans the tool at a plurality of different positons during travelling, the laser sensor will detect a plurality of partial contours of a cross section of the tool. These partial contours can be used for the subsequent analysis.

In some embodiments, determining the plurality of positions in the actual trajectory comprises: determining a plurality of estimated closed contours based on the plurality of scanned contours by fitting a two-dimensional shape to each set of contour points; determining a plurality of center positions of the plurality of estimated closed contours; and determining the plurality of positions based on the plurality of center positions. The scanned contour of the tool is generally a regular two-dimensional shape, such as circle, ellipse, square and rectangle, or some particular shape that can be described be known function. Therefore, with these embodiments, the scanned contour can be complemented by curve fitting based on the contour points to generate an estimated closed contour. The center position of the estimated closed contour may indicate the positions in the actual trajectory. By interpolating between these center positions, the actual trajectory of the tool in the detection plane can be generated.

In some embodiments, adjusting the robot path comprises: determining the theoretical trajectory by fitting the plurality of positions to a predetermined shape trajectory; determining at least one position deviation of at least one deviated position in the actual trajectory from at least one corresponding theoretical position in the theoretical trajectory; and adjusting at least one position in the robot path corresponding to the at least one deviated position based on the at least one position deviation. With these embodiments, the theoretical trajectory can be determined by fitting a trajectory of a predetermined shape to the plurality of positions. The trajectory of a predetermined shape may be any shape that can be described by functions, such as circle, ellipse, straight line, sine cosine curve and hyperbola, as well as some combined trajectories. Therefore, the theoretical trajectory can be accurately determined.

In some embodiments, the method further comprises: in response to determining that a further robot path to be travelled by the robot causes the tool pass through the at least one deviated position, adjusting the further robot path based on the at least one position deviation. With these embodiments, once a deviated position is determined and adjusted, it can be stored and used for other robot path also passing through the deviated position. The applicability of the previously-determined adjustment is increased.

In some embodiments, adjusting at least one position in the robot path comprises: determining an inclined angle of the plurality of estimated closed contours relative to the tool; determining at least one path deviation of at least one deviated position in the robot path corresponding to the at least one position deviation based on the inclined angle; and adjusting at least one position in the robot path corresponding to the at least one deviated position based on the at least one path deviation. With these embodiments, the laser sensor is not calibrated which means a relationship between the coordination system of the laser sensor and the coordination system of the robot or the tool are unknown. Therefore, the inclined angle between the estimated closed contours relative can be used to map the coordinate in the coordination system of the laser sensor into the coordination system of the robot or the tool. After a compensation for the determined deviation is determined, it can be converted into the coordination system of the robot or the tool to update the positions in the robot path.

In some embodiments, determining the inclined angle comprises: in response to determining that a shape of the estimated closed contour has rotational symmetry, determining that the inclined angle is substantially 90 degrees. With these embodiments, when the estimated closed contour is determined to be rotational symmetry, it can be determined that the detection plane is perpendicular to the tool and the compensation for the deviated position can be directly applied to the robot path.

In some embodiments, determining the inclined angle comprises: in response to determining that a shape of the estimated closed contour has reflective symmetry but not rotational symmetry, determining a first geometry size of the estimated closed contour; and determining the inclined angle based on the first geometry size. With these embodiments, the contour of a tool is normally rotationally symmetrical, therefore, when the estimated closed contour is not rotationally symmetrical, it means that the detection plane is not perpendicular to the tool and the inclined angle must be determined. For example, the estimated closed contour may be symmetrical relative to two orthogonal symmetrical axes, namely a long axis and a short axis (similar to ellipse). The inclined angle can be determined by the length of the long axis and the length of the short axis.

In some embodiments, determining the inclined angle further comprises: causing the robot to incline the tool towards the laser sensor; obtaining a scanned contour of the inclined tool by scanning the inclined tool using the laser sensor; determining a second geometry size of an estimated closed contour corresponding to the scanned contour of the inclined tool; and determining an orientation of the plurality of estimated closed contours relative to the tool based on the second geometry size and the first geometry size. With these embodiments, by causing the tool further incline towards the laser sensor, a relative orientation between the tool and the detection plane can be determined.

In some embodiments, obtaining the plurality of scanned contours comprises: causing the robot to stop the tool at a position of the plurality of positions; and obtaining a scanned contour of the plurality of scanned contours by scanning the tool at the position using the laser sensor. With these embodiments, the scanned contour can be obtained at desired positions. Further, since the robot is static when the scanned contour is obtained, the obtain data is more reliable.

In some embodiments, obtaining the plurality of scanned contours comprises: causing the robot to move the tool to travel along the actual trajectory continuously; and obtaining the plurality of scanned contours by scanning the tool using the laser sensor at corresponding time points. With these embodiments, by scanning the tool during travelling, a trajectory of the tool during operation can be obtained.

In some embodiments, the method further comprises: in response to determining that the deviation of the actual trajectory from the theoretical trajectory is greater than a predefined threshold, obtaining a further plurality of scanned contours of the tool held by the robot travelling along the adjusted robot path by scanning the tool using the laser sensor; determining, based on the further plurality of scanned contours, a further plurality of positions in an adjusted actual trajectory of the tool; determining the adjusted actual trajectory based on the further plurality of positions; and further adjusting the adjusted robot path based on a deviation of the adjusted actual trajectory from the theoretical trajectory of the tool. With these embodiments, the method can be iteratively performed.

In some embodiments, the method further comprises: in response to determining that the deviation of the actual trajectory from the theoretical trajectory is less than a predefined threshold, ceasing further adjusting the adjusted robot path. With these embodiments, the iteration may cease until the deviation is tolerable.

In a second aspect, example embodiments of the present disclosure provide a method of adjusting a robot path. The method comprises: obtaining a plurality of scanned contours of a fixed object by scanning the fixed object using a laser sensor held by a robot travelling along the robot path; determining, based on the plurality of scanned contours, a plurality of positions in a relative trajectory of the fixed object with regard to the laser sensor; determining the relative trajectory based on the plurality of positions; and adjusting the robot path based on a deviation of the relative trajectory from a theoretical trajectory of the fixed object with regard to the laser sensor. With these embodiments, the scanned contours are detected relative to the laser sensor. Therefore, in the detection plane formed by the laser sensor, the fixed object moves relatively to the laser sensor. In the meantime, a relative trajectory of the fixed object in the detection plane corresponds to the robot path. Therefore, based on a deviation of the relative trajectory, the robot path can be properly adjusted.

It should be appreciated that the difference between the embodiments of the first aspect and the second aspect is only the positions of the tool and the laser sensor. The trajectory in the detection plane of the tool in the first aspect and the trajectory in the detection plane of the fixed object in the second aspect can be analyzed in the same way. Therefore, embodiments in accordance with the first aspects can be applied in the embodiments in accordance with the second aspects.

In a third aspect, example embodiments of the present disclosure provide a computing device. The computing device comprises: at least one processor; and at least one memory storing instructions that, when executed by the at least one processor, cause the computing device to perform the method for adjusting a robot path.

In a fourth aspect, example embodiments of the present disclosure provide a computer readable medium having instructions stored thereon, the instructions, when executed on at least one processor, cause the at least one processor to perform the method for adjusting a robot path.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an exemplary and in a non-limiting manner, wherein:

FIG. 1 schematically illustrates a block diagram of an example environment in which example embodiments of the present disclosure can be implemented;

FIG. 2 schematically illustrates a flowchart of a method for adjusting a robot path in accordance with embodiments of the present disclosure;

FIG. 3 schematically illustrates a flowchart of a method for adjusting position in the a robot path in accordance with embodiments of the present disclosure;

FIGS. 4A-4D schematically illustrate diagrams of a procedure for adjusting a robot path in accordance with embodiments of the present disclosure;

FIGS. 5A-5D schematically illustrate diagrams of a procedure for adjusting a robot path in accordance with further embodiments of the present disclosure;

FIGS. 6A-6B schematically illustrate schematic diagrams of procedures for determining an orientation of the tool relative to the detection plane

FIG. 7 schematically illustrates a flowchart of a method for adjusting a robot path in accordance with further embodiments of the present disclosure; and

FIG. 8 schematically illustrates a schematic diagram of a computing device for implementing a method in accordance with embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

As described above, in order to improve the end-effector's positioning accuracy of industrial robots, the some solutions are implemented. For example, in some cases, the quality of robot parts and important transmission devices are manufactured with higher precision to reduce mechanical errors which lead to higher production and commissioning costs. In some further cases, manual on-site debugging and correction are implemented which may lead to low efficiency and potential safety problems. In some still further cases, the kinematic calibration of industrial robot introduced to improve the end-effector's positioning accuracy.

Besides there are also solutions with help of auxiliary equipment such as vision cameras and sensors are adopted. However, the cost of auxiliary equipment and commissioning will be increased, and in the meantime it is difficult to apply when the working conditions are limited. Therefore, the effect of these solutions is not ideal and there are still drawbacks for the existing solutions.

In order to at least partially solve the above and other potential problems, a new method is provided for adjusting robot path according to embodiments of the present disclosure. In general, actual trajectory of a robot-held tool in the detection plane of a laser sensor is determined based on a plurality of scanned contours of a cross section of the tool at different positions in the actual trajectory. The deviation of the actual trajectory from a theoretical trajectory can be determined by analyzing the scanned contours. Then, the robot path can be adjusted based on the deviation. The laser-scanned contours obtained have high precision and the use of laser sensor will barely be limited by the environment on site. Therefore, the robot path can be corrected with high precision and low costs.

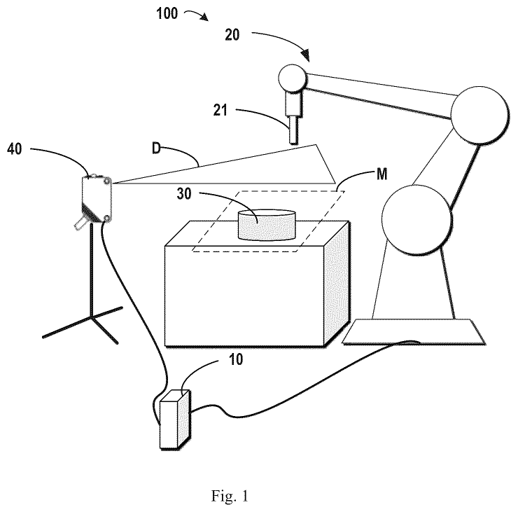

A framework in accordance with embodiments of the present disclosure will be described with reference to FIG. 1. FIG. 1 schematically illustrates a block diagram of an example environment 100 in which example embodiments of the present disclosure can be implemented. In the environment 100, a robot 20 holding a tool 21 is about to perform machining on a workpiece 30. During machining, the robot 20 travels along a robot path and moves the tool 21 on a surface of the workpiece 30 to be machined. The plane in which the surface to be machined is located may be referred to as a machining plane M. Further, a computing device 10 is coupled to and is configured to control the robot 20, for example by giving instructions to the robot 20.

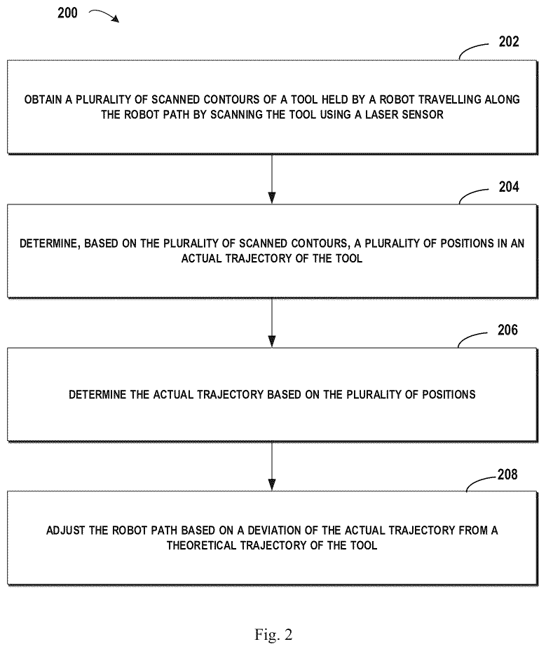

In order to detect the positions of the tool, a laser sensor 40 is provided in the vicinity of working site and couple to the computing device 10. The laser sensor 40 for example is a line laser and configured to employ a laser and an optical lens to project the laser beam as a line and detect the position of points scanned by the laser beam. The line laser beam can form a detection plane D. The positions detected by the laser sensor 40 are in form of coordination in the detection plane D. During machining, the laser sensor 40 emits laser beam onto the side surface of the tool 21 and detects the position of points on a contour of a cross section of the tool 21 in the detection plane D. After the positions are detected, the position data will be transmitted to the computing 10 for subsequent processing. Hereinafter, reference will be made to FIGS. 2 to 5D for more details about the method in accordance with the present disclosure.

FIG. 2 schematically illustrates a flowchart of an example method 200 for adjusting a robot path in accordance with embodiments of the present disclosure. The method 200 may be implemented by the computing device 10 in FIG. 1. At 202, the computing device 10 obtains a plurality of scanned contours of a tool held by a robot, e.g., the robot 20 in FIG. 1, travelling along the robot path. In this case, the scanned contours are obtained by scanning the tool 21 using a laser sensor, e.g., the laser sensor 40 in FIG. 1. When the robot 20 travels along a robot path, the tool 21 is moved by the robot 21 along a machining trajectory on a machining surface of a workpiece 30. When the laser sensor 40 emits laser beam onto the side surface of the tool 21, a scanned contour of the tool 21 can be obtained.

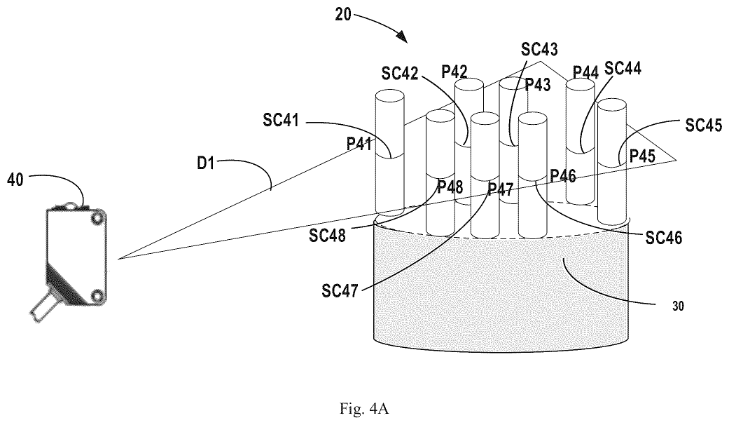

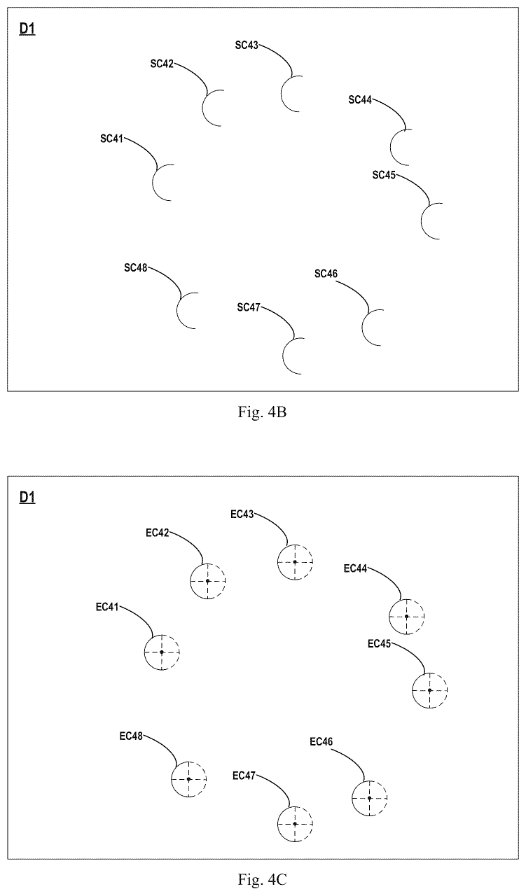

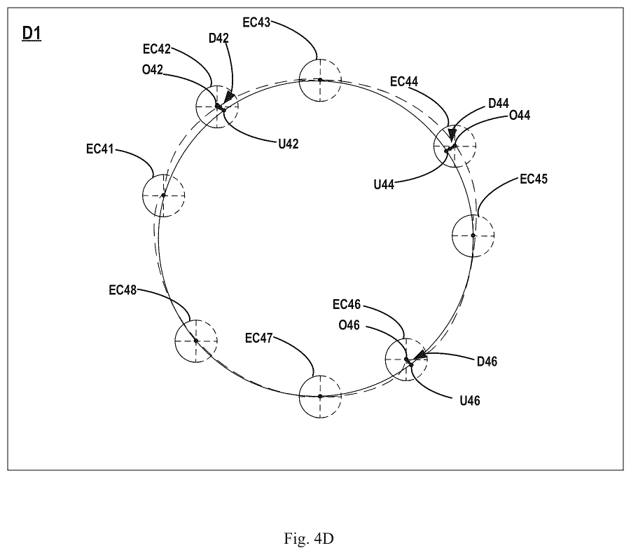

In FIG. 4A, the scanning procedure is schematically illustrated. As illustrated in FIG. 4A, the laser sensor 40 emits a laser beam and forms a detection plane D1. During travelling along a machining trajectory, the tool 21 intersects with the detection plane D1 at position P41, positon P42, positon P43, positon P44, positon P45, positon P46, positon P47 and position P48 respectively. Herein, the trajectory formed in the detection plane D1 during the movement of the tool 21 is referred to as “actual trajectory”. Accordingly, scanned contour SC41, scanned contour SC42 scanned contour SC43, scanned contour SC44, scanned contour SC45, scanned contour SC46, scanned contour SC47 and scanned contour SC48 are obtained by using the laser sensor 40 scanning the tool 21 at these positions. The laser sensor 40 detects the position of the points on the scanned contour and transmits these positions to the computing device 10. The detected positons may be stored in form of point coordination in the detection plane D1.

In some example embodiments, in order to obtain the plurality of scanned contours, the computing device 10 may cause the robot 20 to stop the tool 21 at a position of the plurality of position. When the tool 21 arrives and stops at a predefined position, the laser sensor 40 scans a contour of the tool 21 and transmits the data to the computing device 10, such that the computing device 10 obtains the plurality of scanned contours. In some other embodiments, in order to obtain the plurality of scanned contours, the computing device 10 may cause the robot 20 to move the tool 21 to travel along the actual trajectory continuously. During the movement of the tool 21, the laser sensor 40 may scan the tool 21 at specific time intervals and transmits the data to the computing device 40.

Back to FIG. 2, at 204, the computing device 10 determines a plurality of positions in an actual trajectory of the tool based on the plurality of scanned contours. As described above, the actual trajectory is a trajectory travelled by the tool 21 in the detection plane D. In some example embodiments, in order to determine the plurality of positions in the actual trajectory, the computing device 10 may determine a plurality of estimated closed contours based on the plurality of scanned contours by fitting a two-dimensional shape to each set of contour points. Then, the computing device 10 determines a plurality of center positions of the plurality of estimated closed contours. Finally, the computing device 10 determines the plurality of positions based on the plurality of center positions. This procedure is illustrated in FIGS. 4B-4C.

As illustrated in FIG. 4B, the obtained scanned contours, namely the scanned contour SC41, the scanned contour SC42, the scanned contour SC43, the scanned contour SC44, the scanned contour SC45, the scanned contour SC46, the scanned contour SC47 and the scanned contour SC48 are distributed in the detection plane D1. By processing the positon data of the scanned contour, the computing device 10 may determine that a closed contour corresponding to the scanned contour is a circle. Then, the plurality of estimated closed contours can be obtained based on the plurality of scanned contours by fitting a two-dimensional shape to each set of contour points.

For example, in the example embodiment illustrated in FIG. 4B, the two-dimensional shape is a circle. In FIG. 4C, the estimated closed contour EC41, estimated closed contour EC42, estimated closed contour EC43, estimated closed contour EC44, estimated closed contour EC45, estimated closed contour EC46, estimated closed contour EC47 and estimated closed contour EC48 are illustrated. The position of the center point of the circular estimated closed contour can be used to represent the positons in the actual trajectory. It should be appreciated that the center point is only exemplar. Other specific point of the estimated closed contour can also be used.

Back to FIG. 2, at 206, the computing device 10 determines the actual trajectory based on the plurality of positions. After determining the plurality of positions, the computing device 10 may generate the actual trajectory by interpolating between these positions.

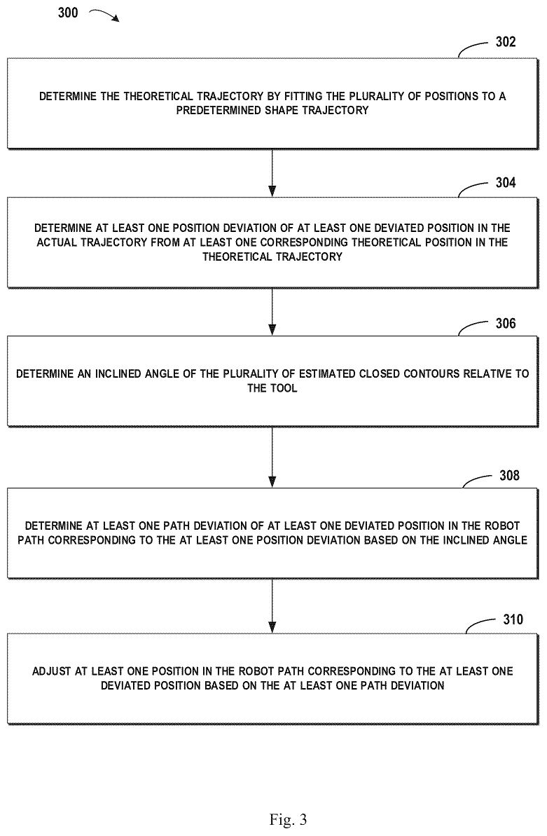

At 208, the computing device 10 adjusts the robot path based on a deviation of the actual trajectory from a theoretical trajectory of the tool. The positions in the actual trajectory can also be used to determine a theoretical trajectory in the detection plane. If the actual trajectory deviates from the theoretical trajectory, the deviation in the detection plane D will be determined by the computing device 10 and then the robot path will be adjusted based on the deviation. The adjusting procedure will be described in further details with reference to the embodiment illustrated in FIG. 3.

In this way, contour sampling data of the tool with high precision can be analyzed to correct the actual path data to fit the desired one, so as to improve the path accuracy. Therefore, by automatically optimizing the path and improving the positioning accuracy through scanned contour sampling data analysis, high-precision positioning can be achieved. Further, compared to vision and manual path correction, the computational complexity is less than that of traditional vision and point cloud computing. Therefore, the processing speed is faster, and the accuracy can be guaranteed.

Hereinafter, the detailed method for adjusting positions in robot path will be described with reference to FIG. 3. FIG. 3 schematically illustrates a flowchart of an example method 300 for adjusting position in a robot path in accordance with embodiments of the present disclosure. The method 300 may be implemented by the computing device 10 in FIG. 1. To ease the understanding, the method 300 will be described in association with FIG. 4D.

At 302, the computing device 10 determines the theoretical trajectory by fitting the plurality of positions to a predetermined shape trajectory. As illustrated in FIG. 4D, by fitting the center points of the estimated closed contours, a theoretical trajectory (as shown in solid line), which is a circle, is determined.

At 304, the computing device 10 determines at least one position deviation of at least one deviated position in the actual trajectory from at least one corresponding theoretical position in the theoretical trajectory. It can be clearly seen from FIG. 4D, there are 3 positions in the actual trajectory deviates from the theoretical trajectory, namely positions of estimated closed contour EC42, estimated closed contour EC44 and estimated closed contour EC46. The centers representing the deviated position are the center O42 of the estimated closed contour EC42, which the center O44 of the estimated closed contour EC44 and the center O46 of the estimated closed contour EC46. On the basis of the time or the length of the tool 21 traveling along the trajectory, corresponding theoretical positions, namely point U42, U44 and U46, are determined. The position deviations between the corresponding theoretical positions and the deviated positions in the actual trajectory can be determined, namely a position deviation D42 extending from the center O42 to the point U42, a position deviation D44 extending from the center O44 to the point U44, and a position deviation D46 extending from the center O46 to the point U46.

At 306, the computing device 10 determines an inclined angle of the plurality of estimated closed contours relative to the tool. Since the deviation is in the detection plane D, that is, the deviation is determined according to the coordination system of the laser sensor 40, it need to be mapped into the coordination system of the robot 21, so that the computing device 10 can adjust the robot path based on the mapped deviation.

In some embodiments, the inclined angle can be determined based on the geometry of the shape of the estimated closed contour. For example, in the embodiment as illustrated in FIGS. 4A-4D, the detection plane D1 is perpendicular to the tool 21. Since the shape of the estimated closed contour is a circle and the inclined angle is substantially 90 degrees. The determined deviation can be applied to adjust the robot path by translation conversion of the coordination. In some alternative embodiments, the laser sensor 40 may be calibrated in the coordination system of the robot. In these embodiments, the deviation can be directly applied.

At 308, the computing device 10 determines at least one path deviation of at least one deviated position in the robot path corresponding to the at least one position deviation based on the inclined angle. After the inclined angle is determined, the deviation in the detection plane D will be mapped into the coordination system of the tool 21 or the robot 20. The coordination system of the tool 21 is associated with the coordination system of the robot 20.

At 310, the computing device 10 adjusts at least one position in the robot path corresponding to the at least one deviated position based on the at least one path deviation. The computing device updates the previous coordination based on the mapped path deviation. In some embodiments, when the computing device 10 determines that a further robot path to be travelled by the robot 20 will cause the tool 21 pass through the at least one deviated position, the computing device 10 adjusts the further robot path based on the at least one position deviation.

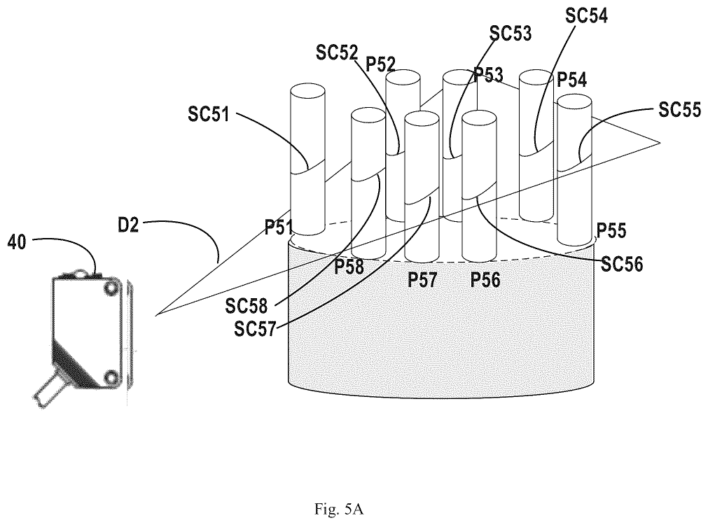

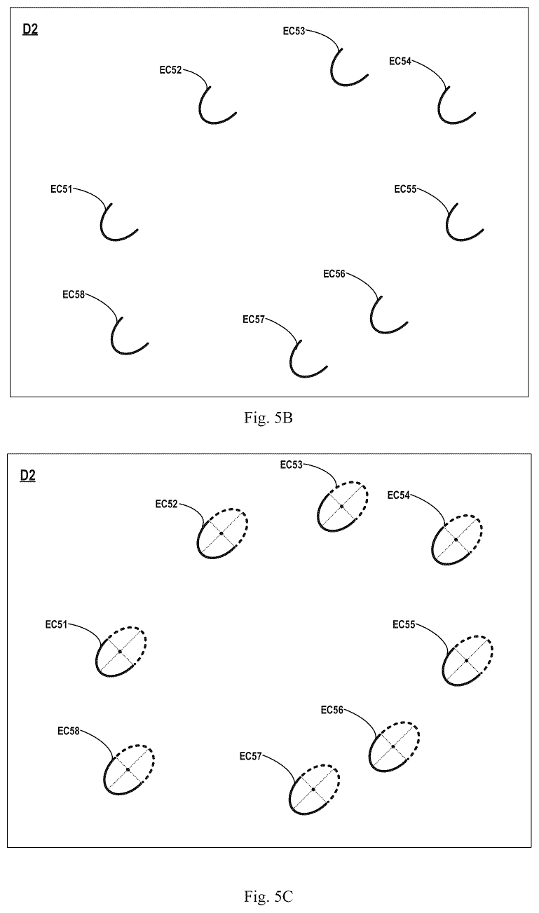

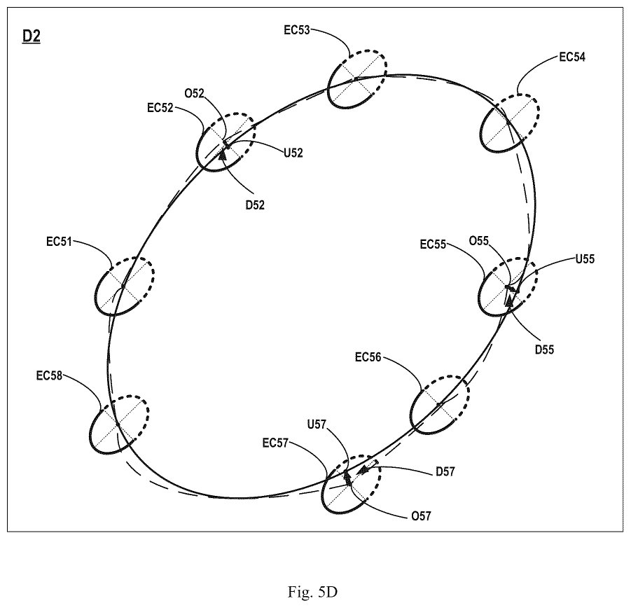

In conclusion, the method provided by example embodiments of the present disclosure is simple and effective, ensures the accuracy, saves human and material resources and improves the efficiency. For the actual application site, it greatly saves the time of on-site debugging for operators. The method provided by example embodiments of the present disclosure is low-cost, high-efficiency and ensures the path accuracy and quality at the same time. Hereinafter, an example procedure for adjusting positions in robot path in accordance with a further embodiment of the present disclosure will be described with reference to FIGS. 5A-5D.

As illustrated in FIG. 5A, the laser sensor 40 emits a laser beam and forms a detection plane D2. In this illustrated embodiment, the detection plane D2 is inclined relative to the tool 21. During travelling along a circular robot path, the tool 21 intersects with the detection plane D2 at position P51, positon P52, positon P53, positon P54, positon P55, positon P56, positon P57 and position P58 respectively. The trajectory formed in the detection plane D2 during the movement of the tool 21 is also referred to as “actual trajectory”. Accordingly, scanned contour SC51, scanned contour SC52 scanned contour SC53, scanned contour SC54, scanned contour SC55, scanned contour SC56, scanned contour SC57 and scanned contour SC58 are obtained by using the laser sensor 40 scanning the tool 21 at these positions. The laser sensor 40 detects the position of the points on the scanned contour. The detected positons may be stored in form of point coordination in the detection plane D2.

In FIG. 5B, the obtained scanned contours, namely the scanned contour SC51, the scanned contour SC52, the scanned contour SC53, the scanned contour SC54, the scanned contour SC55, the scanned contour SC56, the scanned contour SC57 and the scanned contour SC58 are distributed in the detection plane D2. By processing the positon data of the scanned contour, the computing device 10 may determine that a closed contour corresponding to the scanned contour is circle. Then, the plurality of estimated closed contours can be obtained based on the plurality of scanned contours by fitting a two-dimensional shape to each set of contour points. For example, in the example embodiment illustrated in FIG. 5B, the two-dimensional shape is an ellipse.

In FIG. 5C, the estimated closed contour EC51, estimated closed contour EC52, estimated closed contour EC53, estimated closed contour EC54, estimated closed contour EC55, estimated closed contour EC56, estimated closed contour EC57 and estimated closed contour EC58 are illustrated. The position of the center point of the circular estimated closed contour can be used to represent the positons in the actual trajectory.

Since the positions of the center points of the estimated closed contours are determined. The actual trajectory (as shown in dash line) is determined. By fitting the center points of the estimated closed contours, a theoretical trajectory (as shown in solid line), which is a circle, is determined. It can be clearly seen from FIG. 5D, there are 3 positions in the actual trajectory deviates from the theoretical trajectory, namely positions of estimated closed contour EC52, estimated closed contour EC54 and estimated closed contour EC56. The centers representing the deviated position are the center 052 of the estimated closed contour EC52, which the center O54 of the estimated closed contour EC54 and the center O56 of the estimated closed contour EC56. On the basis of the time or the length of the tool 21 traveling along the trajectory, corresponding theoretical positions, namely point U52, U54 and U56, are determined. The position deviations between the corresponding theoretical positions and the deviated positions in the actual trajectory can be determined, namely a position deviation D52 extending from the center O52 to the point U52, a position deviation D54 extending from the center O54 to the point U54, and a position deviation D56 extending from the center O56 to the point U56.

Different from the embodiment as illustrated in FIGS. 4A-4D, the detection plane D2 is inclined relative to the tool 21 and the estimated closed contour does not have rotational symmetry but has reflection symmetry. In this embodiment, in order to determine the inclined angle, the computing device 10 may determine a geometry size of the estimated closed contour. For example, in the illustrated embodiment, the estimated closed contour is an ellipse. Generally, a cross section perpendicular to an axis of the tool 21 may have rotational symmetry. Therefore, a cross section inclined relative to the tool 21 may have reflective symmetry and have a long symmetrical axis and a short symmetrical axis. The short symmetrical axis is orthogonal to and shorter than the long symmetrical axis. For example, in case of an estimated closed contour of ellipse, the long symmetrical axis is the long axis of the ellipse and the short symmetrical axis is the short axis of the ellipse. Therefore, the inclined angle can be determined based on a rate of the short symmetrical axis to the long symmetrical axis.

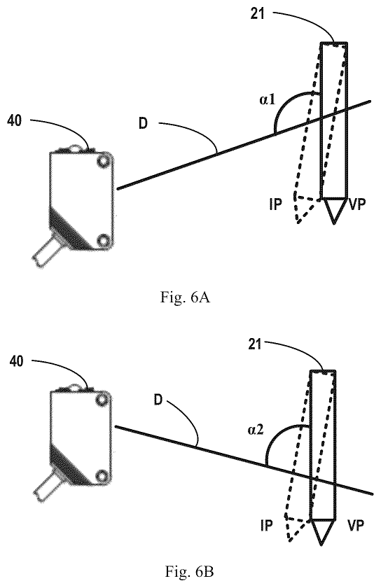

However, the calculated inclined angle may indicate two situations, namely two different orientations of the estimated closed contours relative to the tool 21. In some example embodiments, in order to determine the orientation, the computing device 10 may cause the robot 20 to incline the tool 21 towards the laser sensor 40. Then, the laser sensor 40 detects a new scanned contour of the inclined tool 21 and transmits the contour data to the computing device 10. Upon receiving the contour data, the computing device 10 determines a second geometry size of an estimated closed contour corresponding to the scanned contour of the inclined tool 21. Finally, the computing device 10 determines an orientation of the plurality of estimated closed contours relative to the tool 21 based on the second geometry size and the first geometry size. For example, if the second geometry size is larger than the first geometry size, the estimated closed contour extends from the laser sensor 40 away from a tip of the tool 21, namely the inclined angle is an obtuse angle. Relatively, if the second geometry size is smaller than the first geometry size, the estimated closed contour extends from the laser sensor 40 towards a tip of the tool 21, namely the inclined angle is an acute angle. This procedure is illustrated in FIGS. 6A-6B.

In FIGS. 6A-6B, since the orientation is relative, the tool 21 is illustrated in a vertical posture VP without loss of generality. As illustrated in 6A, the detection plane D extends from the laser sensor 40 towards the tool 21 and inclines away from the tip of the tool 21 to form an inclined angle α1. In order to determine whether α1 is acute or obtuse, the computing device 10 may instruct the robot 20 to further incline the tool 21 towards the tool 21 to an inclined posture IP. The laser sensor 40 scans a scanned contour of tool 21 in the inclined posture IP and transmits the new contour data to the computing device 10. The computing device 10 processes the new contour data and determines a new geometry size of the new contour (also referred to as “second geometry size”). Then, the computing device 10 compares the new geometry size with the previous determined geometry size. In the illustrated embodiment, the new geometry size is larger. Therefore, the inclined angle α1 is determined to be obtuse.

As illustrated in FIG. 6B, although the previously-determined geometry size is the same as that in the embodiment as illustrated in FIG. 6A, similar to FIG. 6A, the tool 21 in FIG. 6B is also inclined by the robot 20 further towards the laser sensor 40. The obtained new geometry size of new contour is smaller. Then, the computing device 10 determines that the inclined angle α2 is acute. In this way, the orientation of the estimated closed contour relative to the tool 21 can be easily determined.

In some alternative embodiments, the long symmetrical axis of the estimated closed contour may be a detected in form of a vector. The orientation of the estimated closed contour relative to the tool may be determined based on the vectorized long symmetrical axis.

Back to the embodiment as illustrated in FIGS. 5A-5D, after the inclined angle and an orientation are determined, the position deviation D52, D54 and D56 can be mapped into the coordination system of the tool 21. Then the computing device 10 may determine a path deviation in the coordination system of the tool 21 or in the coordination system of the robot 20 and adjust the corresponding position in the circular robot path with the path deviation.

In this way, although the laser sensor 40 is not calibrated, by determining the inclined angle and the relative orientation between the detection plane and the tool based on the geometry of the estimated closed contour, the adjusting of a robot path can also be achieved. It should be noted that the shape of the actual path in the robot coordination system is not relevant. Once the deviation between the actual trajectory and the theoretical trajectory in the detection plane is compensated, the path deviation in the robot coordination system will also be compensated no matter what the shape of the robot path is.

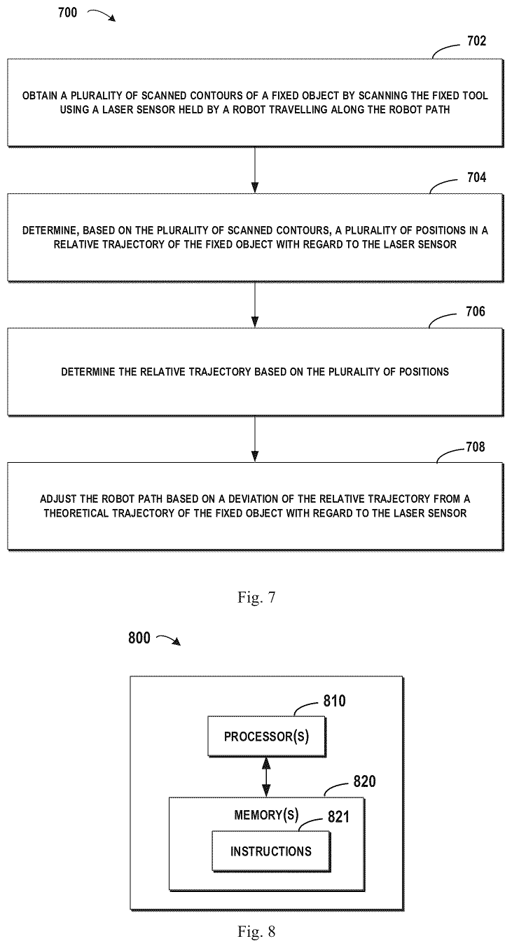

Alternatively, the position of the laser sensor 40 and the tool can be exchanged. FIG. 7 schematically illustrates a flowchart of an example method 700 for adjusting a robot path in accordance with further embodiments of the present disclosure. The method 700 may be implemented by the computing device 10 in FIG. 1.

At 702, the computing device 10 obtains a plurality of scanned contours of a fixed object by scanning the fixed object using a laser sensor held by a robot travelling along the robot path. In this case, the scanned contours are obtained by scanning the a fixed object using a laser sensor. When the robot travels along a robot path, the laser sensor is moved by the robot along a trajectory. The fixed object may be located remotely from the robot but still on site. Alternatively, the fixed object may be located on the robot. During the traveling of the laser sensor, in the detection plane formed by the laser beam emitted by the laser sensor, the fixed object moves relative to the laser sensor and the shape of the relative trajectory of the fixed object corresponds the robot path.

At 704, the computing device 10 determines a plurality of positions in a relative trajectory of the fixed object with regard to the laser sensor based on the plurality of scanned contours. As described above, the relative trajectory is a trajectory travelled by the fixed object in the detection plane.

At 706, the computing device 10 determines the relative trajectory based on the plurality of positions.

At 708, the computing device 10 adjusts the robot path based on a deviation of the relative trajectory from a theoretical trajectory of the fixed object with regard to the laser sensor. The positions in the relative trajectory can also be used to determine a theoretical trajectory in the detection plane. If the relative trajectory deviates from the theoretical trajectory, the deviation in the detection plane will be determined by the computing device 10 and then the robot path will be adjusted based on the deviation. The adjusting procedure is similar to the procedure described with reference to the embodiment illustrated in FIGS. 3-6D.

In some embodiments of the present disclosure, a computing device is provided for implementing the above methods 200, 300 and 700. FIG. 8 illustrates a schematic diagram of a computing device 800 for implementing a method in accordance with embodiments of the present disclosure. The computing device 800 comprises: at least one processor 810 and at least one memory 820. The at least one processor 810 may be coupled to the at least one memory 820. The at least one memory 820 comprises instructions 822 that when executed by the at least one processor 810 implements the method 200, 300 or 700.

In some embodiments of the present disclosure, a computer readable medium for adjusting robot path is provided. The computer readable medium has instructions stored thereon, and the instructions, when executed on at least one processor, may cause at least one processor to perform the method for managing a camera system as described in the preceding paragraphs, and details will be omitted hereinafter.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2, 3 and 7. Generally, program modules include routines, programs, libraries, objects, classes, components, data structures, or the like that perform particular tasks or implement particular abstract data types. The functionality of the program modules may be combined or split between program modules as ideal in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. A method for controlling an industrial robot, comprising:
determining a motion mode for the industrial robot based on a first voice input;
determining one or more motion parameters in the determined motion mode based on a second voice input; and
controlling the industrial robot to move in the determined motion mode according to the one or more motion parameters.

2. The method of claim 1, wherein determining the motion mode comprises:
determining a mode identifier based on voice recognition to the first voice input; and
determining the motion mode based on the mode identifier and a Dynamic Link Library (DLL) encapsulated in the industrial robot, the DLL storing a plurality of predetermined modes and a plurality of predetermined parameter ranges for controlling a movement of the industrial robot.

3. The method of claim 2, wherein controlling the industrial robot to move comprises:
obtaining a predetermined parameter range corresponding to the determined motion mode from the DLL;
determining a validity of the one or more motion parameters based on the predetermined parameter range; and
in response to determining that the one or more motion parameters are valid, controlling the industrial robot to move according to the one or more motion parameters.

4. The method of claim 3, wherein determining the validity of the one or more motion parameters comprises:
determining whether each of the one or more motion parameters is within the predetermined parameter range; and
in response to determining that each of the one or more motion parameters is within the predetermined parameter range, determining that the one or more motion parameters are valid.

5. The method of claim 3, wherein the plurality of predetermined modes include at least a joint angle mode and a Cartesian spatial pose mode, the joint angle mode indicates that a movement of the industrial robot is represented by an angle of a joint, and the Cartesian spatial pose mode indicates that a movement of the industrial robot is represented by a Cartesian Coordinate System.

6. The method of claim 5, wherein determining the validity of the one or more motion parameters comprises:
in response to determining that the determined motion mode is the joint angle mode, comparing a number of joints indicated in the one or more motion parameters to a number of joints of the industrial robot; and
in response to determining that the number of joints indicated in the one or more motion parameters exceeds the number of joints of the industrial robot, determining that the one or more motion parameters are invalid.

7. The method of claim 5, wherein determining the validity of the one or more motion parameters comprises:
in response to determining that the determined motion mode is the Cartesian spatial pose mode, determining a sum of squares of quaternion values included in the one or more motion parameters; and
in response to determining that the sum of squares is not equal to 1, determining that the one or more motion parameters are invalid.

8. The method of claim 1, wherein controlling the industrial robot to move comprises:
receiving a real-time position from a sensor of the industrial robot; and
controlling the industrial robot to move according to the real-time position data.

9. The method of claim 1, wherein the motion mode and the one or more motion parameters are represented in a text format.

10. The method of claim 1, further comprising:
receiving a first recognized result of the first voice input and a second recognized result of the second voice input from an Industrial Personal Computer,
wherein determining the motion mode comprises determining the motion mode based on the first recognized result, and
wherein determining the one or more motion parameters comprises determining the one or more motion parameters based on the second recognized result.

11. The method of claim 10, wherein the first recognized result and the second recognized result are obtained through noise reduction.

12. The method of claim 1, wherein controlling the industrial robot to move comprises:
converting the one or more motion parameters into a control signal; and
control the industrial robot to move according to the control signal.

13. An industrial robot, comprising:
a processor; and
a non-transitory computer readable memory coupled to the processor and comprising instructions that when executed by the processor, cause the processor to perform the method according to claim 1.

14. A non-transitory computer readable medium having instructions stored thereon, the instructions, when executed by a processor, cause the processor to perform the method according to claim 1.

15. A computer program product embodied on a non-transitory computer readable medium, the non-transitory computer readable medium having instructions stored thereon, the instructions, when executed by a processor, cause the processor to perform the method according to claim 1.
